(19) United States
(12) Patent Application Publication
(10) Pub. No.: US 2005/0100329 A1
(43) Pub. Date: May 12, 2005

(54) Mobile and vehicle-based digital video system

(76) Inventors: Ich-Kien Lao, Raleigh, NC (US); Albert J. Dalola, Cary, NC (US); William B. Silvernail, Raleigh, NC (US); Randy Grey Martinez, Burlington, NC (US)

Correspondence Address: HUTCHISON & MASON PLLC, PO box 31686, RALEIGH, NC, 27612, US

(21) Appl. No.: 10/703,258

(22) Filed: Nov. 7, 2003

(51) Int. Cl. H04N 5/76; H04N 5/225

(52) U.S. Cl. 386/117; 348/207.99

(57) ABSTRACT

A digital recording device that is optimized for field use in motor vehicles, and methods for capturing, storing, and retaining digital information recorded by such digital recording device, are disclosed. The digital recording device comprises a non-removable hard disk drive for data storage, eliminating the need to use removable media cartridges, and a small control panel, and is packaged in a ruggedized, compact form factor.

### CROSS-REFERENCE TO PRIOR APPLICATIONS

This application claims the benefit of U.S. Provisional Application No. 60/379,676, filed on Nov. 8, 2002, and is incorporated herein by this reference.

### BACKGROUND OF THE INVENTION

A variety of conventional mobile and vehicle-installed video systems have been developed which provide the ability to capture, record and playback activity recorded in proximity to the capturing equipment. One such solution integrates a commercial magnetic tape recorder mounted in a vehicle trunk or under the seat, dashboard or windshield mounted camera(s), human and/or vehicle microphone system, video display, audio speaker, and remote control station playback control keys. Current solutions distribute equipment and device functions to separate physical locations within a vehicle. Equipment located in the vehicle trunk may utilize an enclosure that provides additional protection and may also provide environmental conditioning.

Mobile and vehicle-installed recording systems are used by law enforcement agencies, among others, to capture video and audio information related to law enforcement activities. Such activities include routing traffic stops, arrests, surveillance, and the like (each, an “event”). Recording such events allows law enforcement agencies to corroborate the recollections, and testimony where applicable, of law enforcement officers. By recording other information along with such audio and video data, it becomes possible to compile a cohesive set of facts related to an event. Such other information can include the date and time of day, speed data captured from a radar gun device, and data from the vehicle in which such a recording system is installed, such as the vehicles speed, ambient temperature, humidity, and the like.

Examples of conventional analog video camera systems are disclosed in U.S. Pat. No. 4,789,904 entitled “Vehicle Mounted Surveillance and Videotaping System” by Peterson, U.S. Pat. No. 6,028,528 entitled “Apparatus and Methods for Managing Transfers of Video Recording Media used for Surveillance from Vehicles” by Lorenzetti and Blanco, and U.S. Pat. No. 5,408,330 entitled “Video Incident Capture System” by Squicciarini and Elcom. Each of these known prior art references disclose certain aspects of existing analog video tape recording systems.

It is recognized in the art that one primary problem with prior art systems is that they record information to removable magnetic media such as video tape cartridges. The use of removable magnetic media increases the difficulty of transferring the video and audio information to an information management system, and also makes the information vulnerable to defects and damage due to handling of the removable cartridges.

### SUMMARY OF THE INVENTION

The present invention discloses methods and apparatus for classifying certain information at the moment that it is recorded, thereby allowing the recorded information to be quickly and easily transferred to an intelligent information management system.

The present invention provides a method whereby digitally captured video and audio information, as well as other information, may be transferred from a vehicle-installed or other mobile system to an information management system without the necessity to utilize magnetic tape or any other removable recording or transfer medium. A removable digital recording device provides the ability to transfer digitally recorded information from the vehicle to the information management system easily. The utilization of a removable digital recording device that uses a recording medium other than magnetic tape provides an efficient and more reliable mechanism to transfer this information.

The present invention further provides the capability to transfer information from a digital recording device mounted in a vehicle to an information management system using a wireless network. Examples of wireless networks that are suitably enabled for use in conjunction with the present invention include, but are not limited to, wide area public networks (e.g., cellular voice and data networks), wide area private networks (e.g., private public safety networks), local area networks (e.g., local area network wireless LANs in proximity to a dedicated site for information download or linking), and local area networks for wide area geographic wireless coverage (e.g., a network of local area network devices linked together to provide a side area geographic network).

In one embodiment of the present invention a single physical enclosure is located within a vehicle passenger compartment that accepts a digital recording device, and a second physical enclosure may be located in a non-mobile location. The present invention discloses a portable removable digital recording device that records video, audio, and other information directly to a recording medium other than magnetic tape. A docking station is used to provide a physical interconnection between a removable and portable recording device and an existing information management system as well as to video and audio playback equipment. A vehicle-based docking station provides a physical interconnection for the removable and portable recording device to the power system, data control and interface(s) and complementary electronic equipment (for example, one or more cameras, one or more microphones, a video monitor, and the like). A latching and securing mechanism provides a controlled insertion and attachment means for physically connecting a docking station and the removable portable recording device. An automatically actuated protective plate is used to protect the interconnect system of the removable and portable recording, storage and control device. The present invention provides a single point of control for the all of the associated peripheral components that connect to the digital recording device, and locates all information capture and playback controls located within close proximity to the end-user operator. This is in contrast with prior art solutions that distribute the components of such a system at various locations within a vehicle.

The present invention provides a method to capture still images when the portable digital recording device is installed in a vehicle and then to distribute the images, when appropriate, through wireless networks for immediate notification to other potential users of the availability of such images. Potential applications for the present invention include distribution of photographs of missing children, of persons wanted by law enforcement agencies, and of missing or stolen vehicles. With the inclusion of a wireless network, still images can be collected in remote locations and sent to others in remote locations.

A method is also provided to continuously scan video and/or audio information stream(s) for objects that may be recognized using specialized software applications. A method is further provided whereby such a software application may continuously monitor video and/or audio information for certain patterns, and to compare such patterns to known patterns contained in one or more databases. Additional information such as the date, time of day, vehicle performance data, and the like, (collectively, “complementary data”) can be encoded to accompany the audio and video information and may be synchronized therewith. The present invention provides methods to continuously monitor a video information stream, whether collected in real-time or post-event, and to discern objects within such video information. Other applications of the present invention include continuous monitoring of the video information stream collected by a moving police patrol vehicle and detecting/recognizing passing automobile license plates. As the passing license plates are decoded, a software application operating in the background compares such images against a known database and provides an alert to a user when a match is detected. The present invention is equally suited for other tasks that may include facial recognition, audio speech pattern recognition as well as other patterns.

The present invention provides a method to automatically adjust the audio level of such audio information provided as an input to the digital recording device. A method is provided to automatically provide corrective compensation to the audio spectrum contained in the audio information presented as an input to the digital recording device in order to achieve a more desired audio record.

The present invention provides a method whereby a continuously operated buffer may contain video, audio and/or complementary information that can be overwritten if retention of such recorded information is not needed. The present invention discloses a method whereby a signal is sent to the digital recording device that commands the digital recording device to retain the buffered information to be included with the desired recorded information associated with an event. For example, the digital recording device may buffer a certain amount of information prior to the start of an event, and then automatically be commanded to save both the buffered information as well as the information associated with the event. This capability enables the recording of information that occurred before the digital recording device was commanded to begin recording an event. This capability allows an end-user operator to witness an event, record the event, and upon playback see the entire event, including those actions that occurred before recording was commanded, thereby providing context for the event. Each event is recorded as a unique and separate file on the digital recording device thus providing efficient search and retrieval of archived video and audio information segments.

The present invention provides a method whereby digital information may be captured and compressed into a format to reduce the amount of storage space required. Various compression techniques may be utilized to reduce the file size of the information that is recorded and stored. Some standard compression formats that may be used include MPEG-2, MPEG-4 and/or Wavelet.

The present invention provides a method whereby the control of one or more cameras may be accomplished remotely from the digital recording device thus eliminating the need for the user to perform and control functions at the camera. For example, a law enforcement officer may choose not to initiate the recording of an event until after exiting his vehicle, and then initiate the recording of an event from outside of the vehicle. The present invention provides a method whereby a wireless camera may be utilized to provide video information that may be captured and recorded by the digital recording device. This capability would allow for a primary or secondary camera to be used to capture events that are outside the field of view of a fixed camera. A wireless interface between the wireless camera and the digital recording device allows the wireless camera to be mobile and carried upon the person of an end-user operator.

The present invention provides a method whereby user-defined rules may be used to automatically determine which information should be uploaded from a digital recording device to an information management system.

The present invention provides a method whereby multiple cameras may be used to send video information to a single digital recording device, and whereby recorded video information may be displayed on a single display device attached to such digital recording device in a split-frame or picture-in-picture format.

The present invention provides a method whereby a camera, an in-vehicle microphone, and a liquid crystal display (LCD) may all be mounted on a single mounting platform in a fashion that allows such single mounting platform to be installed in a vehicle using a single attachment point.

The present invention provides a method whereby a camera with an adjustable focal length lens may be commanded by a digital recording device to zoom to a predetermined focal length. Such command may be initiated by an external input to the digital recording device, or may be pre-programmed, or may be initiated by an end-user operator. The control of the camera may be further enhanced to automatically adjust for ambient lighting conditions to ensure that an image of a vehicle license plate is suitable captured by the digital recording device.

The present invention provides a method whereby an image of a driver's license may be recorded and visually optimized by a single action taken within the vehicle where the digital recording device is installed, such as depressing a single button or selecting an icon, or the like.

The present invention provides a method whereby a single-frame of video information may be recorded by the digital recording device, and then made accessible by other equipment installed within the vehicle such as a laptop or other computer system.

The present invention provides a method whereby the digital recording device may capture, record, transfer, and/or subsequently transmit information received from other sensors and/or in-vehicle information systems, such as a vehicle's Controller Area Network (CAN), vehicle speed sensors, air bag sensors, pressure sensors, and the like, to external monitoring equipment.

The present invention provides a method whereby the digital recording device may include a data interface and data protocol allowing for integration and communication with in-vehicle computer systems, such data interface and/or data protocol comprising Ethernet, serial (RS-232, RS-485), wireless, Controller Area Network (CAN), laptop, TCP/IP, USB, BlueTooth, infrared (IR), Firewire (IEEE-1394), and the like.

The present invention provides a method whereby a digital recording device may be automatically turned on or off based on the necessity and rules to transfer information between the digital recording device and an information management system. For example, an information management system can send a command to a digital recording device to begin to upload information upon the detection of certain parameters, such as the percentage of internal memory available in a given digital recording device. In an alternate embodiment, a digital recording device may be suitable enabled to monitor all messages emanating from a given information management system such that the digital recording device is commanded to begin uploading information upon command. Once the information has been uploaded, the information management system could then command the digital recording device to switch itself off.

The present invention provides a method whereby a remote wireless microphone, connected to a digital recording device via a wireless interface, may be automatically activated by the digital recording device based upon external inputs to the digital video recording device. For example, such a wireless microphone may be commanded to switch on when the digital recording device is switched on or when it begins recording.

The present invention provides a method whereby the digital recording device may be commanded to retain buffered information and to continue recording for a designated period based upon a signal from an in-vehicle sensor, thereby acting as a “blackbox” recording device.

The present invention dicloses a digital recording device that includes an indicator that indicates when the digital recording device is performing an operation such as recording, and may be suitably enabled to communicate other information to an end-user operator as well.

The present invention provides a method whereby the digital recording device may be configured with various features and capabilities in a single step thereby enabling compatibility with an information management system.

The present invention provides a method whereby the digital recording device may be programmed to record information based upon a set of rules downloaded to the digital recording device from an information management system.

The present invention provides a method whereby the information recorded by the digital recording device may be recorded at varying resolutions in order to interoperate with different communications networks operating at differing bandwidths.

The present invention provides a method whereby the camera may automatically change certain parameters to optimize picture quality based upon existing ambient lighting conditions, zoom setting, focal length, shutter speed, and the like.

Additionally, the present invention provides a method whereby the audio spectrum of an audio signal captured by a microphone may be manipulated to provide optimal recording characteristics. For example, in the event that the sound pressure level of the audio signal changes to a point that would provide an undesirable recording, this method provides techniques that allow for dynamic adjustments. If the audio signal captured by the microphone has a distortion that would provide an undesirable recording, the invention employs techniques that can automatically compensate or adjust the audio signal to produce a more desirable recording.

The present invention provides a method whereby a wireless camera may be utilized to provide video information that may be captured and recorded by the digital recording device.

The present invention provides a method to encode alternate complementary data streams to accompany the recorded audio and video stream and that are synchronized therewith on a frame-by-frame basis. This capability enables an end-user operator to encode various useful information that is directly associated with the recorded audio and video information to provide a more useful recording. One example of such complementary date includes recording Global Positioning System (GPS) location information that is directly linked to the captured audio and video information. This link provides an accurate reference point for a video/audio frame if necessary. As a vehicle is moved while capturing digital video and audio information, the GPS information is also updated and can directly link the captured video and audio information on a frame-by-frame basis to a specific geographic location.

The present invention provides a method whereby camera control may be done remotely from the digital recording device thus eliminating the need for the user to perform and control functions at the camera. The capability to control the camera remotely via a serial interface and control interface provides the capability for the digital recording device to establish initialization setting that are based upon startup criteria as well as continuously monitor and control the camera for optimized performance.

The present invention provides a method whereby a single button may be depressed within the vehicle to optimize the recording of a driver's license image by the digital recording device and stored in an event file.

The present invention provides a method whereby a single-frame image may be captured during a recording. The single-frame (or multi-frame) image may be made available to external equipment which may include a laptop computer located within a vehicle or other computer system.

The present invention provides a method whereby a digital recording device may automatically be turned on or off based on the programmed rules that dictate the transfer of information between a digital recording device and a information management system.

The present invention provides a method whereby a wireless microphone may be automatically activated based on external sensors.

The present invention provides a method whereby with the connection to in-vehicle sensors and a continuously recorded buffer the car may perform “blackbox” or pre-crash (accident) recording.

The present invention provides a method whereby the recording light emitting diode (LED) may flash with varying frequency to portray different information to a user.

The present invention provides a method whereby the digital recording device may be configured with various features and capabilities for an information management system with a single downloaded “personality file.”

The present invention provides a method whereby the recorded information may be recorded at varying resolutions to provide for a low resolution information ‘stream’ for low bandwidth networks.

Several advantages of the present invention include: (1) the ability to transfer audio, video, and other recorded information to an information system from a digital recording device without having to handle a recording medium; (2) a mounting system designed to provide controlled insertion of a digital recording device to both an in-vehicle docking station and a non-mobile docking station; (3) the elimination of an enclosure in the trunk of a vehicle; (4) a single physical device capture, recording and playback system that is located in close proximity to the end-user operator; (5) the ability for electronic equipment located within a vehicle's passenger compartment to passively monitor activity that is within the field of view of one or more cameras and one or more microphones located within a vehicle's passenger compartment or elsewhere, and to interoperate with a database to alert an end-user operator when known objects or patterns are detected; (6) the ability to automatically adjust levels and characteristics of the audio signals captured by one or more microphones in order to achieve a more desired input to a digital recording device; (7) the ability to capture video, audio and other information prior to initiating action to record an event; (8) improved quality, reliability and security for such a digital recording device achieved through innovative design and employment of a novel mechanical latching system and automatically actuated interconnect connector protective plate.

A more complete understanding of the present invention, as well as other features and advantages of the invention will be apparent from the following detailed description and the accompanying drawings.

### BRIEF DESCRIPTION OF THE DRAWINGS

The invention is better understood by reading the following detailed description of an exemplary embodiment in conjunction with the accompanying drawings, wherein:

FIG. 1 illustrates a block diagram of a conventional vehicle video and audio recording system;

FIG. 2 illustrates a block diagram of a digital video and audio recording system in accordance with an exemplary embodiment of the present invention;

FIG. 3 illustrates a docking station with a digital recording device inserted therein for use in the passenger compartment of a vehicle in accordance with an exemplary embodiment of the invention;

FIG. 4A illustrates an oblique front view of a docking station for use in the passenger compartment of a vehicle in accordance with an exemplary embodiment of the invention;

FIG. 4B illustrates an oblique rear view of a docking station for use in the passenger compartment of a vehicle in accordance with an exemplary embodiment of the invention;

FIG. 5 illustrates an oblique rear cutaway view of a docking station further illustrating a novel latching mechanism;

FIGS. 6A, 6B, 6C and 6D illustrate four steps in the insertion of a digital recording device into a docking station;

FIG. 7 illustrates an oblique rear view of a removable and portable digital recording device showing a protective plate covering an interconnection connector of such digital recording device in an undocked configuration in accordance with an exemplary embodiment of the present invention;

FIG. 8 illustrates a process for communicating information via an indicator on the front panel of a digital recording device;

FIG. 9 illustrates a process for automatically adjusting the zoom feature of a camera;

FIG. 10 illustrates a process for controlling a buffer of a digital recording device in accordance with the present invention;

FIG. 11 illustrates a process for transferring data from a digital recording device to an information management system;

FIG. 12 illustrates a process for controlling the operation of a digital recording device in response to a set of rules downloaded to the digital recording device.

### DETAILED DESCRIPTION OF THE INVENTION

The following description of the present invention is provided as an enabling teaching of the invention in its best, currently known embodiment. Those skilled in the relevant art will recognize that many changes can be made to the embodiment described, while still obtaining the beneficial results of the present invention. It will also be apparent that some of the desired benefits of the present invention can be obtained by selecting some of the features of the present invention without using other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof, since the scope of the present invention is defined by the claims.

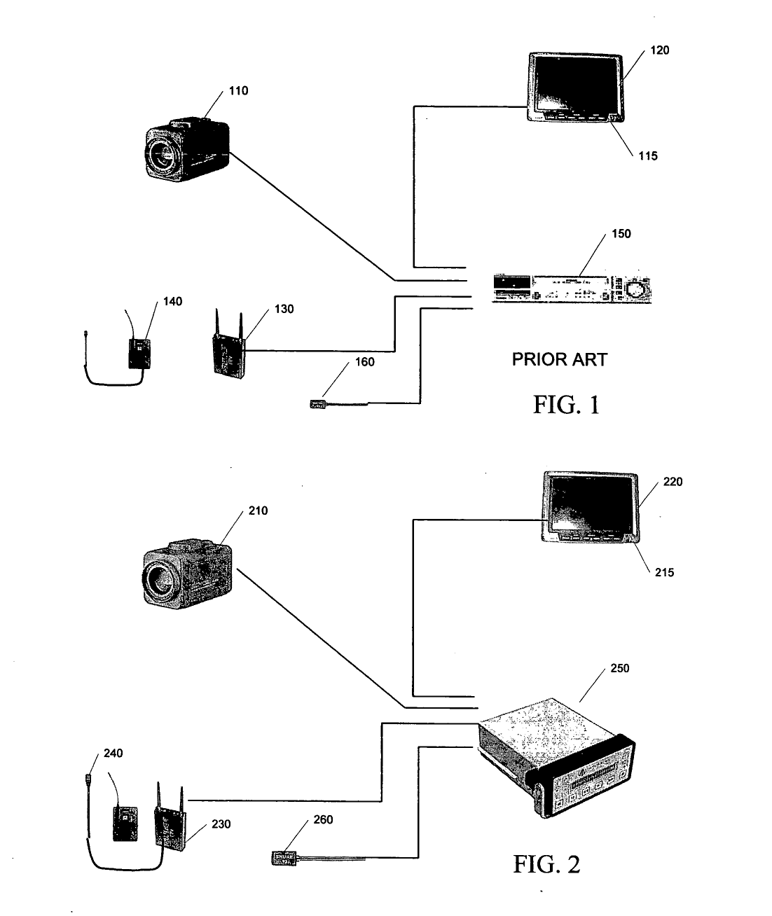

FIG. 1 is an example of a conventional system that records video and audio information on a magnetic tape, and that employs multiple components that are located within a vehicle. The system includes an analog magnetic media recorder 150, a video monitor 120, a camera 110, a speaker 115, a wireless radio receiver 130, an audio microphone 160, and a wireless audio microphone 140. The analog recorder 150 is frequently located in the trunk of a vehicle due to space or environmental constraints, the video monitor 120, the camera 110, the speaker 115, the audio microphone 160, and the wireless radio receiver 130 are all typically located within the passenger compartment of a vehicle, and the audio microphone 140 is typically carried on the person of the end-user operator. Such a system requires installation of cables to multiple locations within a vehicle that may include the vehicle trunk, under the vehicle seat or other vehicle locations. The current system employs magnetic recording medium (typically magnetic tape cartridges in the VHS format) to record captured event information, and to allow transfer of such information to a non-mobile location such as a police station.

FIG. 2 illustrates an example of a digital video and audio recording system. As shown in FIG. 2, the digital video and audio recording system includes a digital recorder 250 and includes a central connection point for power, video and audio signal inputs, and equipment control outputs. The invention utilizes common elements of the conventional system illustrated in FIG. 1 including a video monitor 220, a camera 210, a speaker 215, a wireless radio receiver 230, an audio microphone 260, and a wireless audio microphone 240.

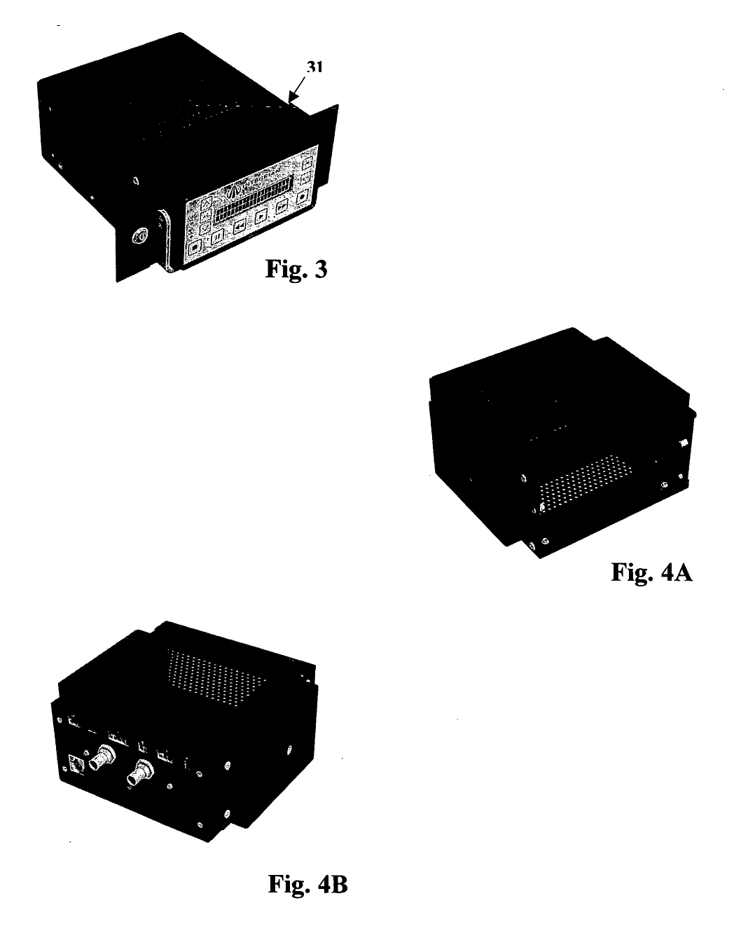

The docking stations illustrated in FIGS. 3, 4 and 5 are complementary to the removable and portable design of the digital recorder disclosed herein and facilitate an efficient method of insertion, interconnection, and removal of the digital recording device 250 illustrated in FIG. 2. The docking station illustrated allows the digital recording device to be installed in a vehicle, as well as in a non-mobile base station integrated into an information management system (not illustrated). By docking the digital recording device in a base station integrated into an information management system, the data contained within said digital recording device may be downloaded to such information management system, thereby allowing such data to be used and thus rendering the digital recording device “ready” for capture and storage of additional and/or new digital video and audio information. FIG. 3 illustrates a docking station for use in a vehicle and includes mounting brackets and a cable interconnection system fir use in vehicle installations. FIGS. 4A and 4B illustrate an oblique front and oblique rear view of a docking station that can be used in a non-mobile location for integration into an information management system (not illustrated), and may be placed on a desktop or rack-mounted.

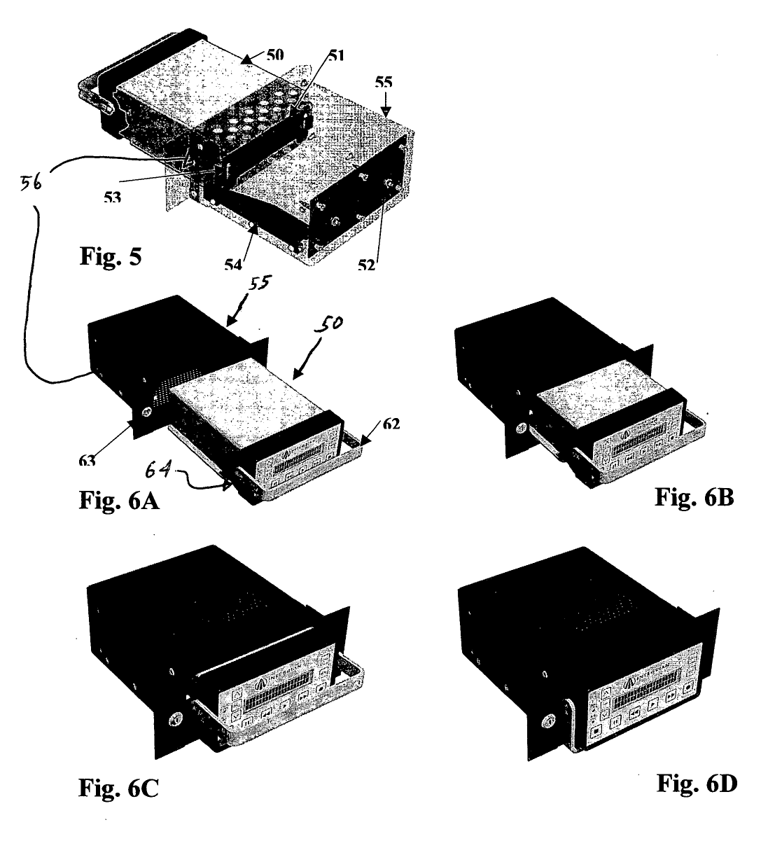

FIG. 5 illustrates an oblique phantom view illustrating a controlled insertion and latch operation that secures the removable digital recording device 50 into a docking station 55 such as the docking station 31 illustrated in FIG. 3. The docking station 55 comprises a rear plate 52 upon which is affixed one or more connectors for electrical power and signals for use in interfacing the docking station to a vehicle or non-mobile information management system and a side rail 54. Side rail 54 engages an alignment pin or tab 53 affixed to a protective plate 51 that is affixed to digital recording device 50. Protective plate 51 is capable of sliding to reveal one or more power and signal connectors on the rear panel of digital recording device 50, and may be spring-loaded to ensure that said protective plate 51 covers the power and signal connector(s) when digital recording device 50 is not docked in a docking station. When digital recording device 50 is inserted into docking station 55, the tab or pin 53 of protective plate 51 engages a graduated rail 54 to slide protective plate 51 open, thereby allowing the connectors of digital recording device 50 to engage the mating connector(s) of rear plate 52. Thus, the controlled insertion of digital recording device 50 into the docking station 55 ensures a reliable interconnection between the two devices. Coupled with the guiding rails and alignment pin, a controlled insertion eliminates the likelihood of a misaligned insertion that may result in damage to the digital recording device and/or the docking station.

FIGS. 6A-6D illustrate an example of docking a digital recording device 50 in a docking station 55. FIGS. 6A-6C depict a digital recording device 50 about to be inserted, partially inserted, and completely inserted into a docking station 55. FIG. 6D depicts digital recording device 50 fully inserted into docking station 55, with carrying/latching handle 62 in the down (latched) position. Carrying/latching handle 62 has one or more cams 64 coincident with the pivot attach point connecting said handle to digital recording device 50. Said cams are suitably positioned such that rotating said handle from the horizontal (insertion/removal) position to the vertical (locked) position engages locking pins 56 (mounted on the side plates of said docking station 55) and draws the connector of the digital recording device and the mating connector of the docking station together. An optional key lock 63 is depicted to illustrate a method to prevent unauthorized removal of the digital recording device 50 from the docking station 55. This optional feature provides both physical security and reduction in the likelihood of disconnection of the power and signal connector(s) from shock and vibration.

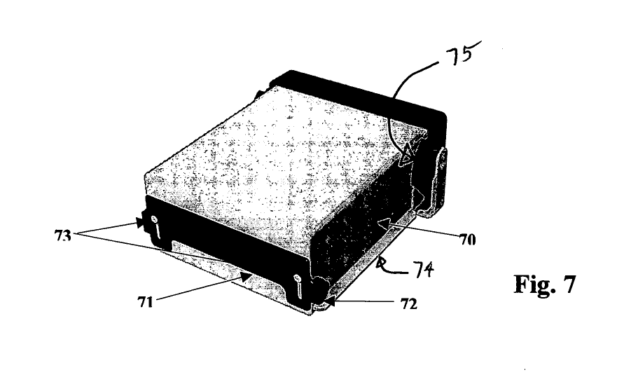

FIG. 7 illustrates a protective plate 71 that is attached to the rear panel of a digital recording device 70 and is used to automatically cover the power and signal connector(s) (hidden behind protective plate 71 and therefore not illustrated) of digital recording device 70. Protective plate 71 is held in place by pins 73 affixed to the rear panel or digital recording device 70. Protective plate 71 may be spring-loaded to move down to cover such power and signal connector(s). Protective plate 71 further comprises one or more alignment tabs or pins 72 that are used to engage a graduated rail when digital recording device 70 is inserted in a docking station, thereby moving said protective plate 71 up to uncover said connectors thereby allowing for the connectors to engage.

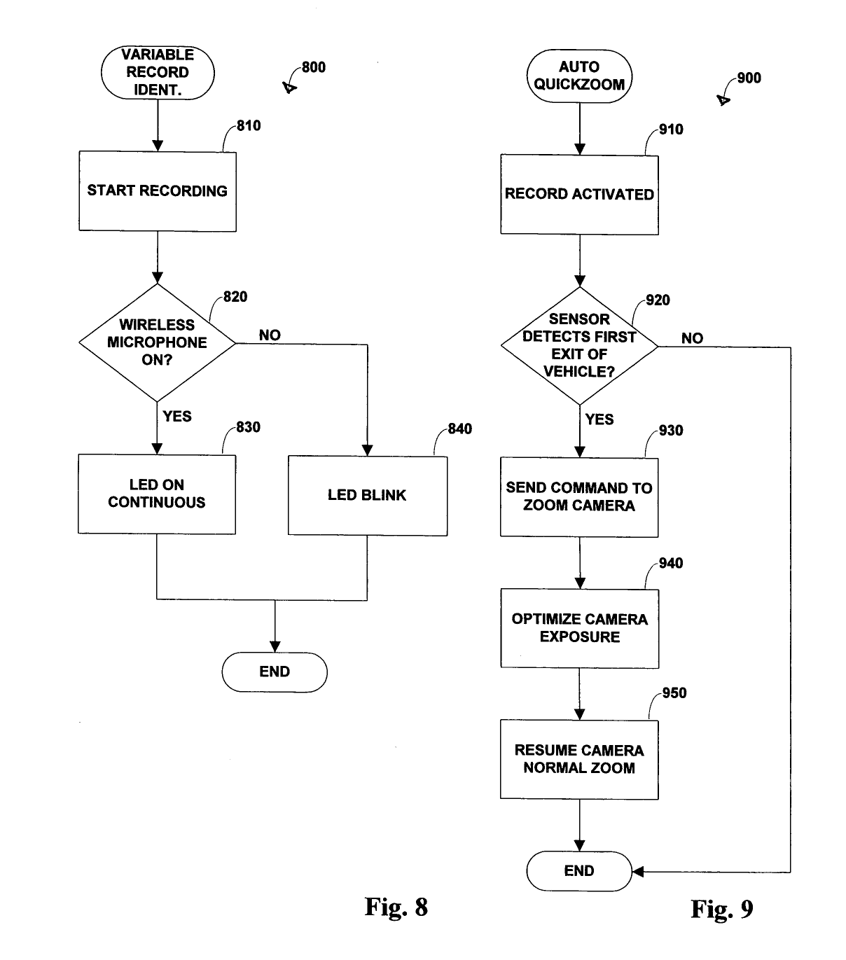

FIG. 8 illustrates a process 800 for communicating information via an indicator on the front panel of a digital recording device in accordance with one aspect of the present invention. The process begins at step 810 where a digital recording device is commanded to begin recording. At step 820, the process determines whether of not a wireless microphone is transmitting to said digital recording device. If not, the process proceeds to step 840 where an indicator, such as an LED, may be commanded to blink to alert the end-user operator of a digital recording device that said wireless microphone is not transmitting. In the event that it is determined at step 820 that said wireless microphone is transmitting to said digital recording device, the process proceeds to step 830 where an indicator, such as an LED, may be commanded to remain continuously lit to alert the end-user operator of a digital recording device that said wireless microphone is transmitting.

FIG. 9 illustrates a process 900 for automatically adjusting the zoom feature of a camera connected to a digital recording device. The process begins at step 910 where a digital recording device is commanded to begin recording (the initiation of a “recording sessior”). At step 920, a sensor, such as a motion sensor, a door switch, or the like, detects that an individual has exited the passenger compartment of a vehicle in which said digital recording device is mounted. If it is determined at step 920 that an individual has exited the passenger compartment of said vehicle for the first time since the recording event was initiated, the process proceeds to step 930 where a command is sent to said camera to initiate a zoom function to narrow the visual field of recording. The process proceeds to step 940 where the process commands the camera to automatically adjust the cameras exposure settings to compensate for the zoomed state. Upon the expiration of a pre-programmed delay, the process proceeds to step 950 where the camera is commanded to reset itself back to the zoom and exposure settings that existed prior to the initiation of the present recording session. Alternatively, the camera may be commanded to revert to pre-programmed default settings. The process then ends. If it is determined at step 920 that such sensor has detected a signal indicating that an individual has exited the vehicle that is subsequent to the original detected signal, the camera settings are not changed and the process ends.

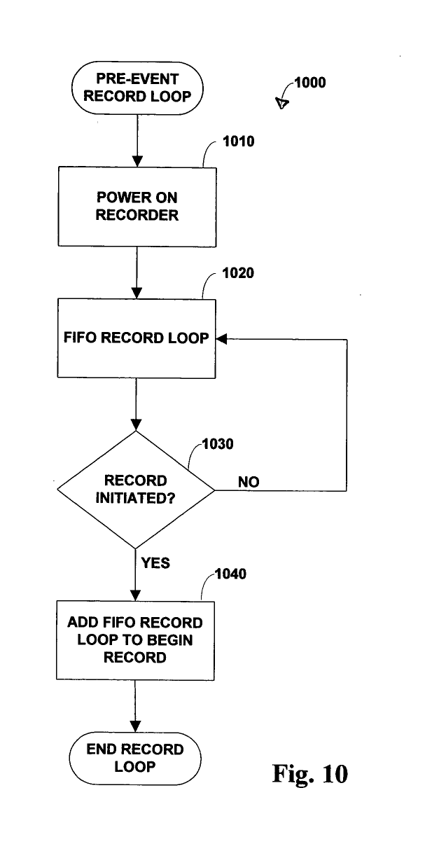

FIG. 10 illustrates a process 1000 for controlling a buffer of a digital recording device in accordance with the present invention. The process begins at step 1010 where a digital recording device is commanded to power-up. The process proceeds to 1020 where said digital recording device is commanded to begin recording to a first in, first out (FIFO) buffer. The process proceeds to step 1030 where it is determined if the end-user operator of has initiated the recording of an event. If so, the process proceeds to step 1040, otherwise the process loops back to step 1020. At step 1040, the recorded information contained in the FIFO buffer is removed from the FIFO buffer and saved in association with the information recorded from the moment the end-user operator initiated the recording of an event. This allows the recorded event information to benefit from the inclusion of the information in the FIFO buffer, thereby providing context for the recorded event information.

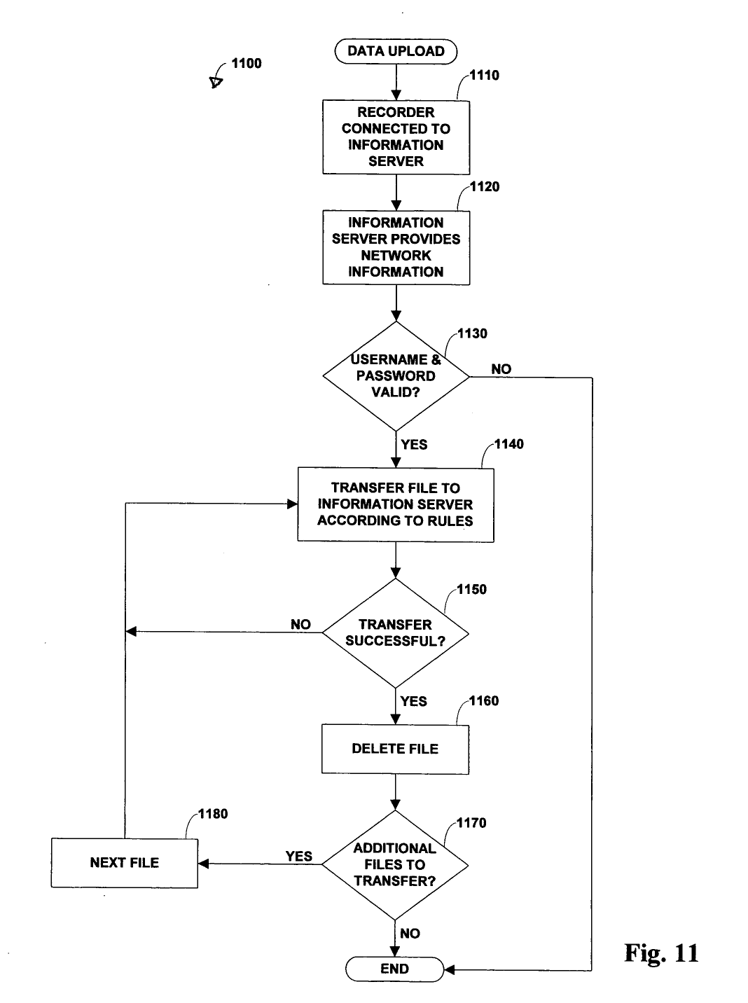

FIG. 11 illustrates a process 1100 for transferring data from a digital recording device to an information management system. The process begins at step 1110 where a digital recording device is connected to an information management system by inserting said digital recording device into a docking station incorporated in the information management system. At step 1120, the information management system sends network information to the digital data recorder. Such network information may include without limitation an IP address, the IP address of a name server or domain server, or other information as required to complete a connection between the digital recording device and the information management system. Proceeding to step 1130, the process authenticates the identity of the digital recording device by validating username and password information that is stored in the digital recording device by means of a “handshake”. If the username and password information is not validated, either because it is incorrect or because the digital recording device has not been previously registered with the information management system, the digital recording device will not be enabled to communicate with the information management system and the process ends. If the username and password information is validated, the process proceeds to step 1140 where information is transferred from the digital recording device to the information management system according to a set of rules. Such rules may include without limitation instructions to transmit priority information, based on classification information associated with a given event, to the information management system, or end-user operator defined criteria that establish which information is necessary to upload to the information management system. In certain situations, an information management system may be configured such that it is not necessary to transmit all stored information to the information management system, but the specific information transmitted is determined by a specific rule. Proceeding to step 1150, the information management system determines whether the transferred information was transferred successfully. If it was not, the process loops back to step 1140. If successful, the process proceeds to step 1160 where the information management system commands the digital recording device to delete the transferred file from storage. Proceeding to step 1170, the information management system determines if there are any other files to be transferred from the digital recording device. If not, the process ends. If it is determined that there are additional files that need to be transferred, the process proceeds to step 1180 where a file counter is incremented, and the process loops back to step 1140 and the file transfer process repeats.

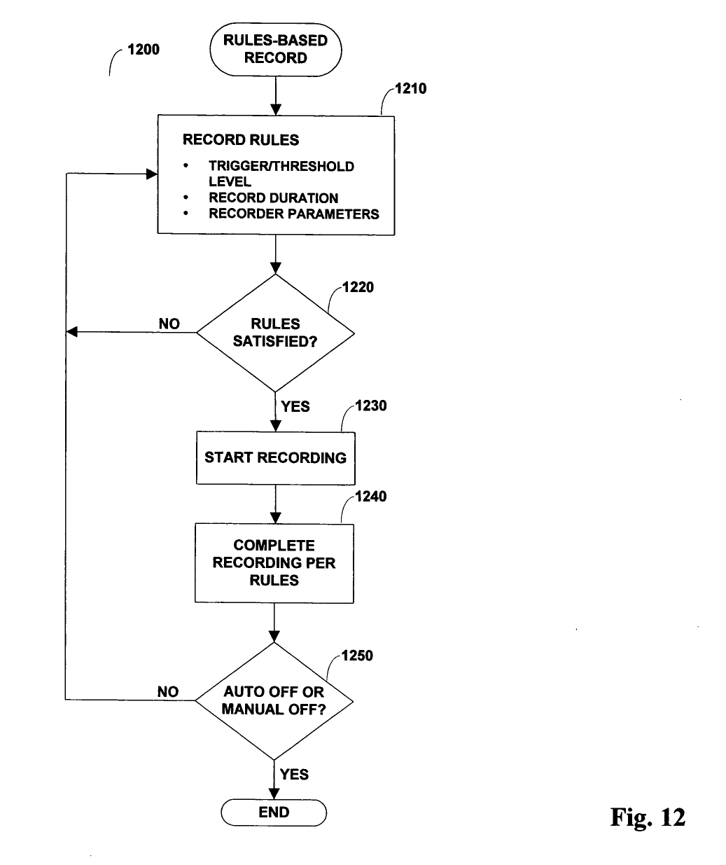

FIG. 12 illustrates a process 1200 for controlling the operation of a digital recording device in response to a set of rules downloaded to the digital recording device. The process begins at step 1210 where a digital recording device is in a “stand-by” mode in anticipation of an instruction to begin recording upon the satisfaction of a pre-programmed rule condition, such as the receipt by the digital recording device of a signal from a speed radar gun indicating that such a radar gun has observed a vehicle raveling in excess of a threshold speed limit. Once the digital recording device has begun recording, it is suitably enabled to continue recording until other rules set forth in step 1210 have been satisfied, such as recording for a pre-programmed duration. Proceeding to step 1220, the process determines whether or not the rules of step 1210 have been satisfied. If not, the process loops back to step 1210. If so, the process proceeds to step 1230 where a digital recording device is commanded to begin recording an event. At step 1240, the process determines whether the recording rules have been completely complied with, and the process proceeds to step 1250. At step 1250, the digital recording device may be commanded to return to “stand-by” and the process returns to step 1210. If not, the digital recording device may be manually switched off and the process ends.

While the invention has been particularly shown and described with reference to an exemplary embodiment thereof, it will be understood by those skilled in the art that various changes in form and detail may be made without departing from the spirit and scope of the invention.

1. A digital recording system, comprising:
a video camera;
a microphone;
a display;
a speaker;
inputs for receiving digital information other than audio and video;
a digital recording medium;
a keypad; and
a docking station.

2. The system of claim 1, further comprising a wireless transceiver and a second microphone, wherein said second microphone is a wireless microphone for communicating with said digital recording system via said wireless transceiver.

3. The system of claim 1 wherein said docking station further comprises a power supply.

4. A digital recording device for recording a plurality of digital signal inputs from one or more cameras, one or more microphones, and one or more other input sources, comprising:
a clock for synchronizing recorded digital inputs;
a control panel for entering user information and controlling functions of said digital recording device;
a display; and
a memory.

5. The digital recording device of claim 4 wherein said memory is a non-removable hard disk drive.

6. The digital recording device of claim 4 wherein each input signal is recorded in a separate file.

7. The digital recording device of claim 6 wherein said digital recording device includes a means responsive to said clock, inputs entered on said control panel by an end-user operator, and other input signals available internal to a motor vehicle for automatically classifying recorded events responsive to such inputs.

8. The digital recording device of claim 7 further comprising means for detecting and recording a synchronizing signal and each such input signal in a relational database.

9. The digital recording device of claim 8 wherein such other input signals include input signals available from a motor vehicle's internal computer system and electrical systems including air bag sensors, a speed sensor, door sensors, radar guns, vehicle warning lights, and sirens.

10. The digital recording device of claim 9 further comprising means for transmitting in real-time via a wireless communications link said synchronizing signal and one or more of said recorded input signals to an information management system.

11. A digital recording system comprising the digital recording device of claim 4 and a docking station for receiving said digital recording device.

12. The digital recording system of claim 11 wherein said digital recording device has a left surface, a right surface, and a back surface, wherein said back surface has a connector; and
wherein said docking station has a left plate, a right plate, and a back plate, wherein said back plate has a mating connector for connecting to the connector on said back surface of said digital recording device.

13. The digital recording system of claim 12 wherein said left surface and said right surface of said digital recording device further comprise a flat rail, and said rear surface of said digital recording device further comprises a protective plate that is spring-loaded to cover said connector when said digital recording device is not inserted in said docking station, and said protective plate comprises one or more alignment pins or tabs; and
said left plate and said right plate of said docking station further comprise a ramp-shaped rail that engages said alignment pins or tabs of the protective plate of said digital recording device when such digital recording device is inserted into said docking station, thereby sliding said protective plate to reveal such connector on said rear surface of such digital recording device, allowing such connector to mechanically mate with said connector on said rear plate of said docking station.

14. The digital recording system of claim 13 further comprising a handle, wherein the ends of such handle further comprise a cam rotationally connected to said left surface and said right surface of said digital recording device, wherein said cams engage locking pins affixed to the left plate and right plate of said docking station.

15. The digital recording system of claim 14 wherein the movement of said handle engages said locking pins thereby forcing said mating connectors to fully engage and locking said digital recording device in said docking station.

16. A method for communicating to an end-user operator the status of a microphone connected to a digital recording device, the method comprising the steps of:
reading a signal from a microphone;
comparing said signal to a reference signal; and
continuously illuminating a light on a control panel if said signal indicates that said microphone is receiving an audio input signal and intermittently illuminating a light on a control panel if said signal indicates that said microphone is not receiving an audio input signal.

17. A method for efficiently searching and retrieving information recorded by a digital recording device, the method comprising the steps of:
recording audio and video information associated with an event to a memory;
storing a clock signal that is synchronized with such audio and video information;
storing additional information associated with events contemporaneous with such recorded audio and video information in a database; and
retrieving segments of such audio or video information based on said clock signal or such additional information stored in said database.

18. The method of claim 17 wherein said additional information comprises:
a unique identification number associated with said event;
the date and time the recording of the event was initiated;
the geographic coordinates associated with each frame of information recorded;
an identification number associated with said digital recording device;
an identification associated with the vehicle in which said digital recording device is installed;
the name and an identification number associated with the end-user operator of said digital recording device; and
a summary of the event recorded.

19. The method of claim 18 wherein said summary of the event recorded comprises standard codes used by law enforcement agencies to categorize law enforcement activities.

20. A method for transferring information recorded from a digital recording device mounted in a motor vehicle to a non-mobile information management system, the method comprising the steps of:
removing said digital recording device from a docking station mounted in a motor vehicle, wherein said digital recording device comprises a hard disk drive memory device;
inserting said digital recording device into a docking station integrated with a non-mobile information management system; and
retrieving said information from such hard disk drive and transferring such information to a second hard disk drive integrated with said information management system.

21. A method for automatically adjusting the focal length of a camera connected to a digital recording device, the method comprising the steps of:
initiating the recording of an event;
detecting a signal to adjust the focal length of said camera;
determining whether such signal is the first such signal detected during the duration of such event;
adjusting the focal length of said camera;
optimizing the exposure parameters of such camera in response to said adjustment of the focal length of said camera; and
resetting the focal length of such camera.

22. The method of claim 21 wherein said signal to adjust the focal length of said camera is a signal indicating that the driver's door of a motor vehicle has been opened.

23. The method of claim 21 wherein upon the passage of a fixed period of time the focal length and exposure parameters of said camera are reset to the settings that existed prior to the initiation of said event.

24. The method of claim 22 wherein upon the detection of the second occurrence of said signal the focal length and exposure parameters of said camera are reset to the settings that existed prior to the initiation of said event.

25. A method for automatically recording information prior to the initiation of a recording session, the method comprising the steps of:
initiating the recording of information and storing such information in a first in, first out (FIFO) buffer;
detecting a signal to initiate the recording of an event and storing such information in a computer file;
upon the detection of such signal, preserving the contents of such FIFO buffer; and
appending the information stored in such FIFO buffer to the beginning of said stored computer file.

26. The method of claim 25 wherein said recording of information and storing such information in a FIFO buffer is automatically initiated whenever a digital recording device is switched on.

27. The method of claim 25 wherein said signal to initiate the recording of an event is received from a speed-measuring device indicating that a vehicle has been detected violating a pre-set speed limit.

28. The method of claim 25 wherein said signal to initiate the recording of an event is received from a vehicle's airbag sensor, and such recording and storing of such information continues for so long as possible.

29. The method of claim 25 wherein said signal to initiate the recording of an event is received from a vehicle's airbag sensor, and such recording and storing of such information continues for so long as possible.

30. A method for transferring recorded information from a digital recording device to an information management system, the method comprising the steps of:
connecting a digital recording device to an information management system;
sending network connection settings from said information management system to said digital recording device thereby enabling said digital recording device to communicate with said information management system;
authenticating the identity of said digital recording device by verifying a username or identification number and a password stored on said digital recording device;
uploading recorded information from a single computer file stored in said digital recording device to the memory of said information management system;
confirming that said uploaded file was transferred successfully;
deleting said uploaded file from the memory of said digital recording device; and
continuing to transfer said computer files until all files have been uploaded.

31. The method of claim 30 further comprising the steps of:
downloading a set of rules from said information management system to said digital recording device prior to uploading any recorded information; and
uploading such computer files from said digital recording device in agreement with such rules.

32. A method transferring recorded information from a digital recording device to an information management system, the method comprising the steps of:
connecting a digital recording device to an information management system via a wireless communications link;
sending network connection settings from said information management system to said digital recording device thereby enabling said digital recording device to communicate with said information management system;
authenticating the identity of said digital recording device by verifying a username or identification number and a password stored on said digital recording device;
transferring control of said digital recording device to an end-user located remotely from said digital recording device thereby allowing said end-user operator to control input devices attached to said digital recording device; and
uploading recorded information from said digital recording device to the memory of said information management system at said end-user operator's discretion.

33. A method for controlling the operation of a digital recording device subject to a set of rules, the method comprising the steps of:
connecting a digital recording device to an information management system;
downloading a set of rules from an information management system to a digital recording device wherein said rules are used to determine when to initiate recording and when to terminate recording;
determining whether one of said rules for initiating the recording of an event has been satisfied;
initiating the recording of information to said digital recording device;
determining whether each of said rules for terminating the recording of an event have been satisfied; and
terminating the recording of such information.

34. The method of claim 33 comprising the further steps of:
upon completing the recording of an event, resetting said digital recording device to a stand-by state; and
monitoring the occurrence of one of said rules for initiating the recording of an event to determine whether to initiate the recording of a subsequent event.
